(19) United States
(12) Patent Application Publication
(10) Pub. No.: US 2011/0068069 A1
(43) Pub. Date: Mar. 24, 2011

(54) Rolling merchandizing device and method of manufacture

(76) Inventor: Raymond J. Starsiak, Laguna Nigle, CA (US)

(21) Appl. No.: 12/924,083

(22) Filed: Sep. 17, 2010

Related U.S. Application Data
(60) Provisional application No. 61/276,952, filed on Sep. 19, 2009.

(51) Int. Cl. A47F 7/00; B60B 33/00

(52) U.S. Cl. 211/85.8

(57) ABSTRACT

The present application is directed to a rolling merchandizing device and includes at least one vertical support member having at least a rear surface, at least one handling member coupled to the vertical support member, the handling member not extending beyond the rear surface of the vertical support member, and at least one horizontal support member coupled to the vertical support member, the horizontal support member having a first wheel set and at least a second wheel set, wherein the transverse dimension of the first wheel set is less than the transverse dimension of the second wheel set.

### CROSS-REFERENCE TO RELATED APPLICATIONS

The present application claims priority to U.S. Provisional Patent Application Ser. No. 61/276,952, filed Sep. 19, 2009, the contents of which is incorporated by reference in its entirety herein.

### BACKGROUND

Presently, the delivery of beverages to retail establishments has been a tedious, time-consuming and labor intensive process. Typically, a delivery truck is loaded with various packages of beverages (i.e. 12 packs of 12 ounce cans, cases of 12 ounces cans, etc.) at distributors. Thereafter, a delivery driver proceeds to the desired retail store. Once at the delivery location, the delivery driver proceeds to manually load a hand truck with the appropriate package containers and transports the packages to a desired display location within the retail store. Once at the display location, the delivery driver manually unloads the hand truck thereby building the product display. This process repeats itself until the construction of the display is completed. Often, this process may take hours to complete. Moreover, very large product displays typically require the delivery driver to repeatedly load and unload the hand truck. In addition, displays are largely immovable once constructed. As such, any desire to reposition or reconfigure the display requires substantial effort in load/unload a hand truck, and reconstruction of the display. This process is exasperated when the products are positioned within a walk-in cooler. Generally, these coolers utilize largely immovable rack systems. As such, reconfiguring product displays or product advertising is challenging if not impossible.

Thus, in light of the foregoing, there is an ongoing need for a rolling merchandizing device capable of transporting and displaying product packages. Ideally, a single rolling merchandizing device would be capable of acting as a hand truck when needed, while being capable of acting as a selectively movable merchandizing stage.

### SUMMARY

The present application is direct to various embodiments of a rolling merchandizing device useful in the effective transport and display of common retail packages in retail settings. In one embodiment, the present application discloses a rolling merchandizing device particularly useful in the transport and display of commonly available beverage packages. More specifically, the present application enables the user quickly and easily to load, transport, and display commonly available beverage packages

In one embodiment, the present application is directed to a rolling merchandizing device and includes at least one vertical support member having at least a rear surface, at least one handling member coupled to the vertical support member, the handling member not extending beyond the rear surface of the vertical support member, and at least one horizontal support member coupled to the vertical support member, the horizontal support member having a first wheel set and at least a second wheel set, wherein the transverse dimension of the first wheel set is less than the transverse dimension of the second wheel set.

In another embodiment, the present application is directed to a rolling merchandizing device and includes at least one vertical support member having at least a rear surface, the vertical support member having a frame member defining a frame region, at least one handling member coupled to the frame member and positioned within the frame region, the handling member co-aligned with the frame member, and at least one horizontal support member coupled to the vertical support member, the horizontal support member having a first wheel set and at least a second wheel set, wherein the transverse dimension of the first wheel set is less than the transverse dimension of the second wheel set.

In still another embodiment, the present application is directed to a rolling merchandizing device and includes at least one vertical support member having at least a rear surface, the vertical support member having a oval shaped frame member defining a frame region, at least one handling member coupled to the frame member and positioned within the frame region, the handling member co-aligned with the frame member, and at least one horizontal support member coupled to the vertical support member, the horizontal support member having a first wheel set and at least a second wheel set, wherein the transverse dimension of the first wheel set is less than the transverse dimension of the second wheel set, wherein the first wheel set comprises at least two wheel systems, and the second wheel set comprises at least two wheel systems, the distance between the wheel systems forming the first wheel set is greater than the distance between the wheel systems forming the second wheel set.

### BRIEF DESCRIPTION OF THE DRAWINGS

FIG. 1 shows a rear perspective view of an embodiment of a rolling merchandizing device;

FIG. 2 shows a front perspective view of an embodiment of a rolling merchandizing device;

FIG. 3 shows a front planar view of an embodiment of a rolling merchandizing device;

FIG. 4 shows a side planar view of an embodiment of a rolling merchandizing device;

FIG. 5 shows a rear planar view of an embodiment of a rolling merchandizing device;

FIG. 6 shows a bottom planar view of an embodiment of a base member of a rolling merchandizing device;

FIG. 7 shows a cross-sectional view of frame member used in an embodiment of a rolling merchandizing device;

FIG. 8 shows various views of an embodiment of a rolling merchandizing device transporting and displaying 42 twelve packs of canned beverages;

FIG. 9 shows various views of an embodiment of a rolling merchandizing device transporting and displaying 21 twenty four packs of canned beverages;

FIG. 10 shows various views of an embodiment of a rolling merchandizing device transporting and displaying 15 thirty packs of canned beverages;

FIG. 11 shows various views of an embodiment of a rolling merchandizing device transporting and displaying 28 eighteen packs of canned beverages;

FIG. 12 shows various views of an embodiment of a rolling merchandizing device transporting and displaying 24 twelve packs of bottled beverages;

FIG. 13 shows various views of an embodiment of a rolling merchandizing device transporting and displaying 12 twenty four packs of bottled beverages;

FIG. 14 shows a top planar view of an embodiment of a rolling merchandizing device;

FIG. 15 shows a schematic view of a layout plan of an end display for use with a six foot aisle in a retail setting;

FIG. 16 shows a schematic view of a layout plan of an end display for use with a four foot aisle in a retail setting; and

FIG. 17 shows a schematic view of a layout plan of stand-alone display for use in a retail setting.

### DETAILED DESCRIPTION

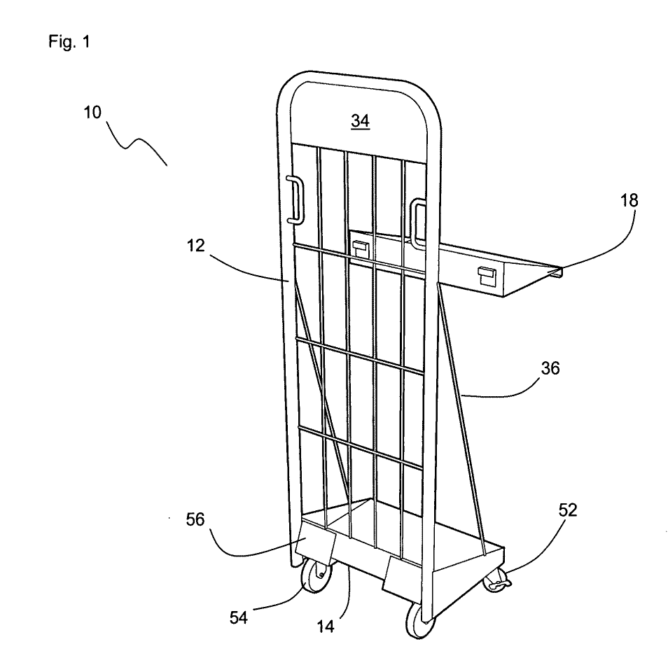

FIGS. 1 and 2 show various views of an embodiment of a rolling merchandizing device. As shown, the rolling merchandizing device 10 includes at least one vertical support body 12 coupled to or otherwise in communication with at least one horizontal support body 14 configured to cooperatively support one or more products or items 16. In the illustrated embodiment, a single vertical support body 12 is coupled to a single support body 14. Optionally multiple vertically support members 12 may be coupled to the horizontal support member 14. Similarly, multiple horizontal support members 14 may be coupled to a vertical support member 12. Additionally, multiple vertical support members 12 may be coupled to multiple horizontal support members 14. Optionally, at least one movable display device 18 may be coupled to the vertical support body 12, the horizontal support body 14, or both. In the illustrated embodiment, the movable display device 18 comprises a tray configured to engage and detachably couple to at least one vertical support body 12, thereby permitting the user to easily add any number of additional product supports to the rolling merchandizing device 10.

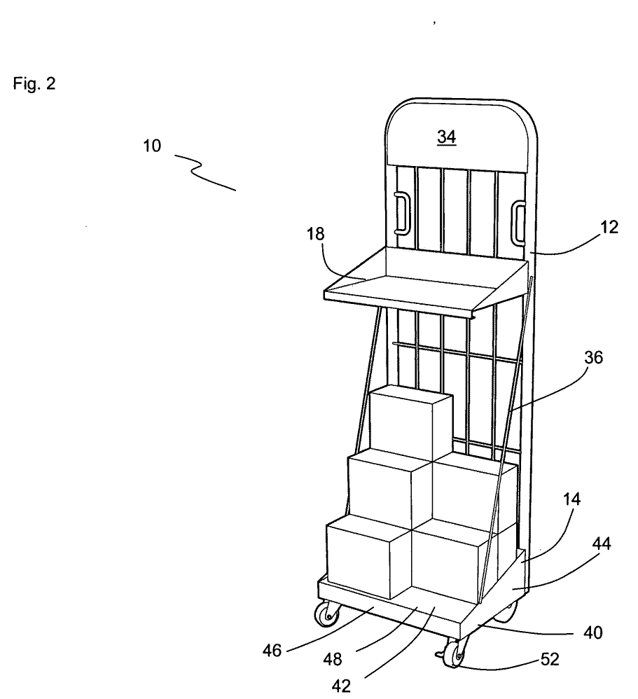

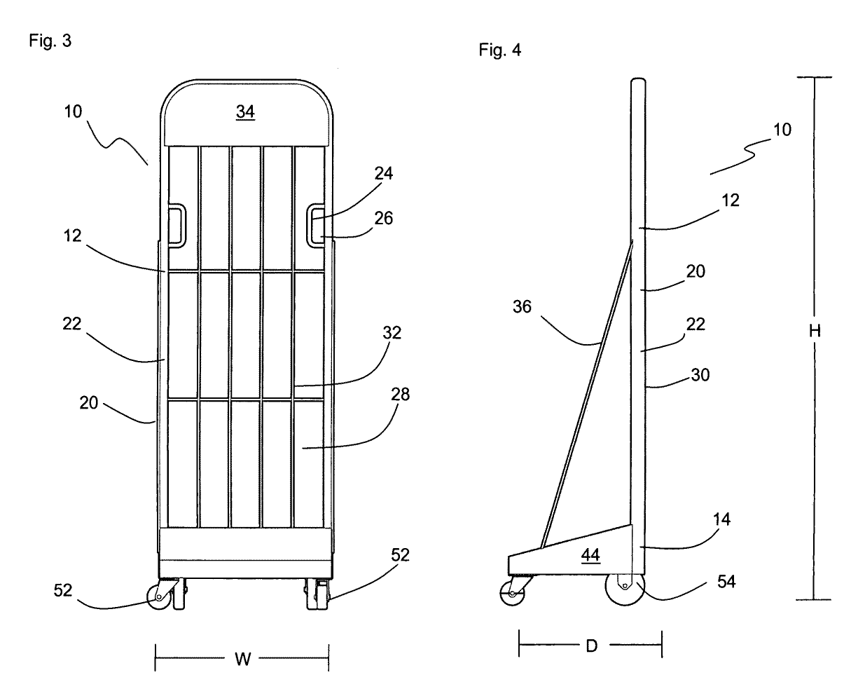

As shown in FIGS. 3-5, the vertical support body 12 may include at least one vertical support frame 20 formed from at least one frame member 22. In one embodiment, the frame members 22 further include at least one handling device 24 defining a gripping region 26 within the frame region 28 formed by the frame members 22. In the illustrated embodiment, the handling device 24 is positioned within the frame region 28, thereby permitting the rear surface 30 of the rolling merchandizing device 10 to be positioned proximate to a wall or other vertical impingement. As such, if desired, multiple rolling merchandizing devices 10 may be positioned with the rear surfaces 30 of each adjacent thereto. In one embodiment, the handling device 24 is integral to the frame member 22 and/or the vertical support member 12. In an alternate embodiment, the handling device 24 is configured to be detachably coupled to at least a portion of the frame member 22 and/or the vertical support member 12.

Referring again to FIGS. 3-5, one or more frame supports 32 may be positioned within or proximate to the frame region 28 formed by the frame members 22. In the illustrated embodiment, the frame supports 32 are oriented vertically and horizontally. Optionally, the frame supports 32 may be vertically oriented, horizontally oriented, or both. Further, in the illustrated embodiment, the frame supports 32 are welded to the frame members 22. Optionally, the frame supports 32 may be coupled to the frame members 22 using any variety of methods, including, without limitations, mechanically coupled with fasteners, adhesively coupled, and the like. In another embodiment, the frame supports 32 may be integrally formed with the frame members 22.

As shown in FIGS. 3-5, the rolling merchandizing device 10 further includes at least one display member 34 formed thereon. In the illustrate embodiment, the display member 34 is formed within the frame region 28 formed by the frame members 22. Optionally, the display member 34 may be positioned outside the frame region 28. For example, the display member 34 may be configured to be detachably coupled to at least a portion of the rolling merchandizing device 10. In an alternate embodiment, a display member 34 may be positioned proximate to the strut support 36 and the frame member 22. For example, the strut support 36 may be welded or otherwise secured to the frame member 22 and at least one display member 34 may be positioned between the strut support 36 and the frame member 22. The display member 34 may be configured to receive one or more display fixtures (not shown) thereon. Exemplary display fixtures include, without limitations, signage, printed advertisements, inflatable devices, illuminated devices, and similar products. Further, the display fixtures (not shown) may be positioned on any surface of the display member 34.

As shown in FIGS. 3-6, the horizontal support member 14 may be coupled to the vertical support member 12. In one embodiment, the horizontal support member 14 is non-detachably coupled the vertical support member 12. For example, the horizontal support member 14 may be welded to the vertical support member 12. In an alternate embodiment, the horizontal support member 14 may be coupled to the vertical support member 12 in any variety of ways, including, without limitations, mechanically coupled, adhesively coupled, integrally formed, and the like. In another embodiment, the vertical support member 12 may be detachably coupled to the horizontal support member using any variety of methods or devices known in the art. In one embodiment, the horizontal support member 14 includes horizontal support frame 40 comprising a base member or plate 42 having at least one wheel set or movement device secured thereto. In the illustrated embodiment, at least one wall member 44 is coupled to the base member 42. Optionally, at least one base support 46 may be coupled to at least one of the base member 42 and/or the wall member 44. In the illustrated embodiment, the base member 42, wall member 44, and base support 46 forms a merchandize display area 48 configured to receive and support merchandise at a desired height. For example, as shown in FIG. 2, the merchandise display area 48 may be configured to support and display various products or items 16 in various orientations. For example, in one embodiment, the merchandise display area 48 may be configured to support and display numerous six packs, twelve packs, eighteen packs, and/or cases of beverages in presently available packages.

Referring again to FIGS. 3-6, the base member 42 includes one or more movement devices thereon. For example, in the illustrated embodiment, the movement device 50 comprises a first wheel set 52 and a second wheel set 54. More specifically, in the illustrated embodiment, the first wheel set 52 comprises two selectively lockable, swiveling casters having a first diameter D₁. Similarly, the second wheel set 54 comprises two fixed position casters having a second diameter D₂. In another embodiment, first diameter D₁ of the first wheel set 52 is greater than the second diameter D₂ of the second wheel set 54. In one embodiment, first diameter D₁ of the first wheel set 52 is less than the second diameter D₂ of the second wheel set 54. For example, in one embodiment, the first diameter D₁ of the first wheel set 52 is about 3 inches while the second diameter D₂ of the second wheel set 54 is about 5 inches. In still another embodiment, first diameter D₁ of the first wheel set 52 is equal to the second diameter D₂ of the second wheel set 54. Optionally, the first wheel set 52, the second wheel set 54, or both sets comprise selectively lockable, swiveling casters. In the alternative, the first wheel set 52, the second wheel set 54, or both sets comprise fixed position casters.

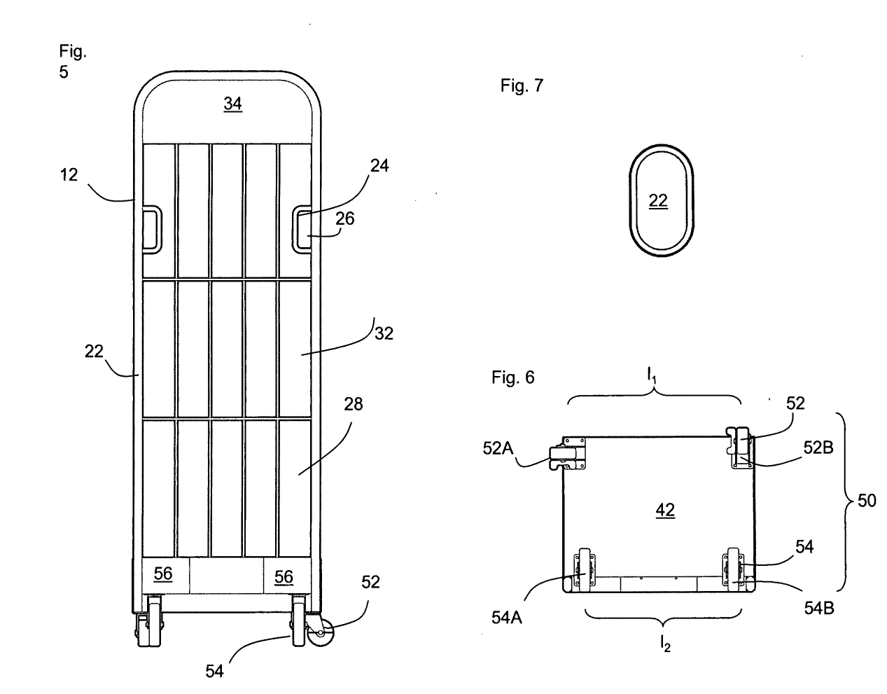

As shown in FIG. 6, the first wheel set 52 comprises a wheel system 52A and a wheel system 52B separated by a distance l₁. Similarly, the second wheel set 54 comprises a wheel system 54A and a wheel system 54B separated by a distance l₂. As shown in FIG. 6, the distance l₁ is greater than the distance l₂. In the alternative, the distance l₁ may be less than the distance l₂. In an alternate embodiment, the distance l₁ is equal to the distance l₂.

Referring again to FIGS. 3-6, the rolling merchandizing device 10 may include one or more support brackets 56 positioned proximate to the rear surface 30 thereof. In one embodiment, the support brackets 56 are configured to support the second wheels set 54 proximate to but not extending beyond the rear surface 30 of the rolling merchandizing device 10. As such, as stated above, the rolling merchandizing device 10 may be positioned adjacent to a vertical impingement.

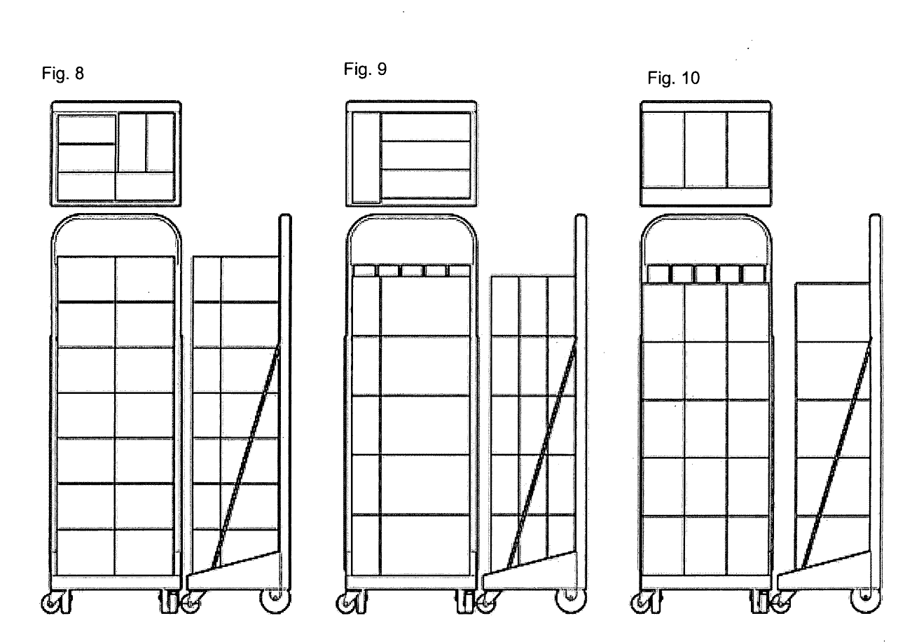

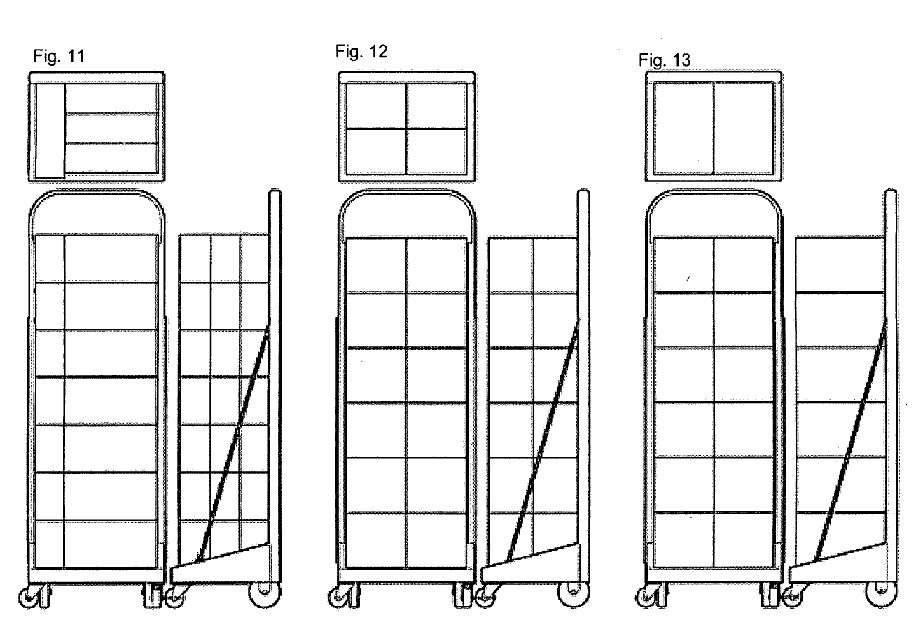

Those skilled in the art will appreciate that the rolling merchandizing device 10, and the various components thereof, may be manufactured from any variety of materials. For example, in one embodiment, the rolling merchandizing device 10 may be constructed from steel. In an alternate embodiment, the rolling merchandizing device 10 may be constructed from aluminum. Optionally, the rolling merchandizing device 10 may be constructed from any variety of materials, including, without limitations, various alloys, steel, titanium, aluminum, polymers, composite materials, fiberglass-impregnated polymers, natural fibers, rubber, silicon, and the like. For example, in the embodiment shown in FIGS. 1 and 2, the frame member 22 comprises an oval shaped member having a transverse dimension of about 1 inch by 1.75 inches (as shown in FIG. 7), the handle member comprising a steel wire having a transverse dimension of about 0.5 inch, and the support members 32 comprising a wire grid, the individual wires having a transverse dimension of about 0.25 inch. Optionally, the rolling merchandizing device 10 may be coated, painted, anodized, or may otherwise receive a surface treatment configured to protector vary the appearance thereof. Those skilled in the art will appreciate that the rolling merchandizing device 10 may be manufactured in any variety of size, widths, heights, depths, and the like. For example, in the embodiment shown in FIGS. 3 and 4, the rolling merchandizing device 10 has a height H of about 68 inches, a width W of about 23 inches, and a depth D of about 17.75 inches. As such, the rolling merchandizing device 10 shown in FIGS. 8-13 described above may be used to transport and display a wide assortment of beverage containers in presently available packaging configurations in a floor area of less than about 3 square feet. For example, the afore-described rolling merchandizing device 10 may easily be configured to transport and display approximately 42 twelve packs of canned beverages (see FIG. 8), approximately 21 twenty four packs of canned beverages (see FIG. 9), approximately 15 thirty packs of canned beverages (see FIG. 10), approximately 28 eighteen packs of canned beverages (see FIG. 9), approximately 24 twelve packs of bottled beverages (see FIG. 9), or 12 twenty four packs of bottled beverages (assuming the each can contained approximately 8 and 18 fluid ounces, and each bottle contained approximately between 12 and 20 fluid ounces).

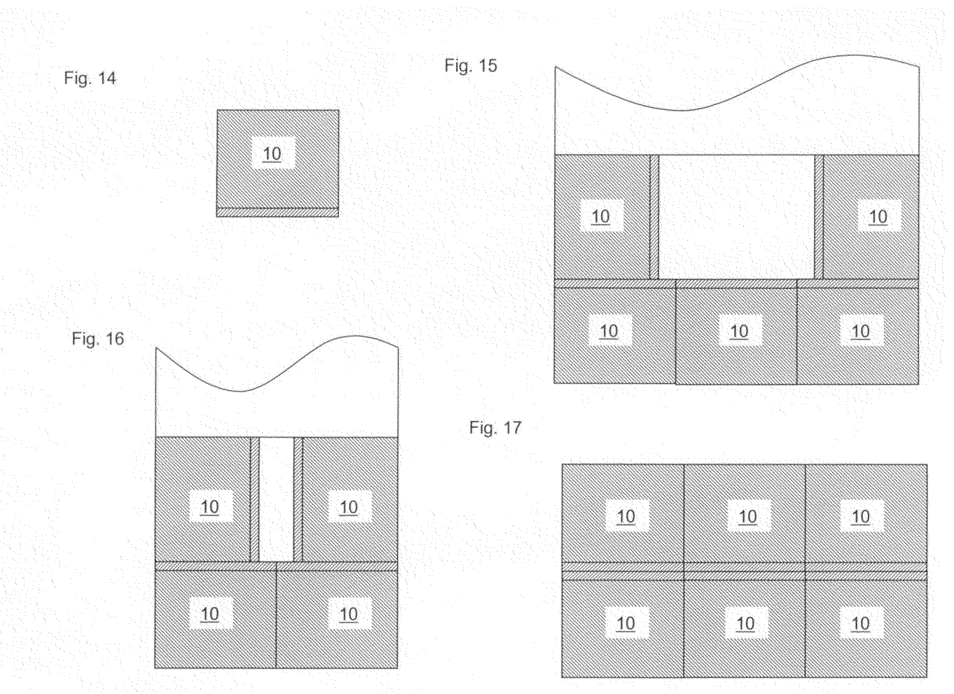

FIGS. 14-16 show various views of an embodiment of a rolling merchandizing device 10 during use. As shown in FIG. 14, the rolling merchandizing device 10 is configured to enable the efficient transport of packaged products, typically beverages, and the display thereof without the tedious and time-consuming prior art process of loading a hand truck or similar device, transporting the merchandise to a desired location, unloading the hand truck, and constructing a largely immovable display. In one embodiment, the transport driver need only load the rolling merchandizing device 10 with the appropriate packaging, transport and position the rolling merchandizing device 10 to a desired location, and engage at least one locking wheel set 52A (See FIG. 2) located on the base member 42 thereby quickly and efficiently forming an easily movable product display. Multiple rolling merchandizing devices 10 may be used to transport a large quantity of products to a desired location and provide a variety of product display architectures for a wide variety of applications. For example, at shown in FIG. 14, a single rolling merchandizing device 10 occupying approximately 3 square feet may be configured to transport and display approximately 42 twelve packs of canned beverages. As shown in FIG. 15, five rolling merchandizing devices 10 may be cooperatively used to provide and end display for a six foot aisle commonly found in the retail industry. In contrast, FIG. 16 shows four rolling merchandizing devices 10 configured to provide an end display for a four foot aisle commonly found in the retail industry. Optionally, as shown in FIG. 17, the rolling merchandizing device 10 is substantially free from impingements proximate to the rear surface 30 (See FIG. 4), thereby permitting multiple rolling merchandizing devices 10 may be positioned with adjacent rear surfaces 30.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. A rolling merchandizing device, comprising:
at least one vertical support member having at least a rear surface;
at least one handling member coupled to the vertical support member, the handling member not extending beyond the rear surface of the vertical support member; and
at least one horizontal support member coupled to the vertical support member, the horizontal support member having a first wheel set and at least a second wheel set, wherein the transverse dimension of the first wheel set is less than the transverse dimension of the second wheel set.

2. The device of claim 1 wherein the vertical support member includes at least one frame member defining a frame region.

3. The device of claim 2 wherein the handling member is positioned within the frame region.

4. The device of claim 2 further comprising at least one support members positioned within the frame region and in communication with the frame member.

5. The device of claim 2 wherein the frame member comprises at least one oval shaped member.

6. The device of claim 1 wherein the handling member is co-aligned with the vertical support member.

7. The device of claim 1 wherein the horizontal support member comprises at least one base member defining a merchandise receiving area, the base member having the first and second wheel sets in communication therewith.

8. The device of claim 7 further comprising at least one of a side wall and a base support coupled to the base member.

9. The device of claim 1 at least one of the first and second wheel sets comprises a selectively lockable, swiveling caster.

10. The device of claim 1 wherein at least one of the first and second wheel sets comprise a non-locking, fixed position caster.

11. The device of claim 1 wherein the first wheel set comprises at least two wheel systems, and the second wheel set comprises at least two wheel systems.

13. The device of claim 11, wherein the distance between the wheel systems forming the first wheel set is less than the distance between the wheel systems forming the second wheel set.

14. The device of claim 1 further comprising a strut support coupled to the vertical support member and the horizontal support member.

15. A rolling merchandizing device, comprising:
at least one vertical support member having at least a rear surface, the vertical support member having a frame member defining a frame region;
at least one handling member coupled to the frame member and positioned within the frame region, the handling member co-aligned with the frame member; and
at least one horizontal support member coupled to the vertical support member, the horizontal support member having a first wheel set and at least a second wheel set, wherein the transverse dimension of the first wheel set is less than the transverse dimension of the second wheel set.

16. The device of claim 15 wherein the frame member comprises at least one oval shaped member.

17. The device of claim 15 wherein the horizontal support member comprises at least one base member defining a merchandise receiving area, the base member having the first and second wheel sets in communication therewith.

18. The device of claim 15 at least one of the first and second wheel sets comprises a selectively lockable, swiveling caster.

19. The device of claim 15 wherein the first wheel set comprises at least two wheel systems, and the second wheel set comprises at least two wheel systems, wherein the distance between the wheel systems forming the first wheel set is less than the distance between the wheel systems forming the second wheel set.

20. A rolling merchandizing device, comprising:
at least one vertical support member having at least a rear surface, the vertical support member having a oval shaped frame member defining a frame region;
at least one handling member coupled to the frame member and positioned within the frame region, the handling member co-aligned with the frame member; and
at least one horizontal support member coupled to the vertical support member, the horizontal support member having a first wheel set and at least a second wheel set, wherein the transverse dimension of the first wheel set is less than the transverse dimension of the second wheel set, wherein the first wheel set comprises at least two wheel systems, and the second wheel set comprises at least two wheel systems, the distance between the wheel systems forming the first wheel set is greater than the distance between the wheel systems forming the second wheel set.
